(19) United States
(12) Patent Application Publication
(10) Pub. No.: US 2025/0034453 A1
(43) Pub. Date: Jan. 30, 2025

(54) FILM AND LAMINATE

(71) Applicant: FUJIFILM Corporation, Tokyo (JP)

(72) Inventors: Shohei YAMAZAKI, Kanagawa (JP); Yasuyuki SASADA, Kanagawa (JP)

(73) Assignee: FUJIFILM Corporation, Tokyo (JP)

(21) Appl. No.: 18/915,299

(22) Filed: Oct. 14, 2024

Related U.S. Application Data
(63) Continuation of application No. PCT/JP2023/015684, filed on Apr. 19, 2023.

(30) Foreign Application Priority Data
Apr. 28, 2022 (JP) 2022-075201

(51) Int. Cl. C09K 19/38

(52) U.S. Cl. CPC C09K 19/3809

(57) ABSTRACT

Provided is a film including a phase-separated structure having at least two phases, in which in a case where a glass transition temperature of a first phase, which is one of the at least two phases, is denoted by Tg1, a second phase which is one of the at least two phases and is different from the first phase does not have an inflection point of a storage elastic modulus in a temperature range of 25° C. or higher and the Tg1 or lower.

### CROSS-REFERENCE TO RELATED APPLICATION

This application is a Continuation of International Application No. PCT/JP2023/015684, filed Apr. 19, 2023, which claims priority to Japanese Patent Application No. 2022-075201 filed Apr. 28, 2022. Each of the above applications is hereby expressly incorporated by reference, in its entirety, into the present application.

### BACKGROUND OF THE INVENTION

### 1. Field of the Invention

The present disclosure relates to a film and a laminate.

### 2. Description of the Related Art

In recent years, a film has been applied to various fields, and performance such as thermal conductivity and low dielectricity is required depending on the application.

JP2021-30631A discloses a laminated film in which a liquid crystal polyester layer in which a filler is not added is laminated on both surfaces of a filler-added layer consisting of a synthetic resin to which a filler is added, as a film.

### SUMMARY OF THE INVENTION

In the film, it may be required to suppress curling.

The present disclosure has been made in view of such circumstances, and an object to be achieved by an embodiment of the present disclosure is to provide a film in which curling is suppressed.

Further, an object to be achieved by another embodiment of the present disclosure is to provide a laminate formed of the film.

The present disclosure includes the following aspects.

<1> A film including a phase-separated structure having at least two phases, in which in a case where a glass transition temperature of a first phase, which is one of the at least two phases, is denoted by Tg1, a second phase which is one of the at least two phases and is different from the first phase does not have an inflection point of a storage elastic modulus in a temperature range of 25° C. or higher and the Tg1 or lower.

<2> A film including a phase-separated structure having at least two phases, in which in a case where a glass transition temperature of a first phase, which is one of the at least two phases, is denoted by Tg1, a melting point of a second phase which is one of the at least two phases and is different from the first phase is higher than the Tg1.

<3> A film including a phase-separated structure having at least two phases, in which in a case where a glass transition temperature of a first phase, which is one of the at least two phases, is denoted by Tg1, a storage elastic modulus of a second phase which is one of the at least two phases and is different from the first phase at a temperature higher than the Tg1 by 25° C. is 0.5 times or more a storage elastic modulus of the second phase at a temperature lower than the Tg1 by 25° C.

<4> The film according to any one of <1> to <3>, in which the second phase has a storage elastic modulus at 25° C. of 10 GPa or less.

<5> The film according to any one of <1> to <4>, in which a dielectric loss tangent is 0.010 or less.

<6> The film according to any one of <1> to <5>, in which a degree of crystallinity is 60% or less.

<7> The film according to any one of <1> to <6>, in which a glass transition temperature is 100° C. to 200° C.

<8> The film according to any one of <1> to <7>, in which a melting point of the second phase is 500° C. or lower.

<9> The film according to any one of <1> to <8>, in which a dielectric loss tangent of the second phase is 0.002 or less.

<10> The film according to any one of <1> to <9>, in which a dielectric loss tangent of the second phase is lower than a dielectric loss tangent of the film.

<11> The film according to any one of <1> to <10>, in which the second phase contains particles.

<12> The film according to any one of <1> to <11>, in which a content of the second phase is 45% by mass or more with respect to a total mass of the film.

<13> The film according to any one of <1> to <12>, in which the first phase contains a liquid crystal polymer.

<14> The film according to any one of <1> to <13>, in which the first phase contains aromatic polyester amide.

<15> The film according to <14>, in which the aromatic polyester amide includes a constitutional unit represented by Formula 1, a constitutional unit represented by Formula 2, and a constitutional unit represented by Formula 3, and with respect to a total content of the constitutional unit represented by Formula 1, the constitutional unit represented by Formula 2, and the constitutional unit represented by Formula 3, a content of the constitutional unit represented by Formula 1 is 30 mol % to 80 mol %, a content of the constitutional unit represented by Formula 2 is 10 mol % to 35 mol %, and a content of the constitutional unit represented by Formula 3 is 10 mol % to 35 mol %.

—O—Ar¹—CO— Formula 1

—CO—Ar²—CO— Formula 2

—NH—Ar³—O— Formula 3

In Formula 1 to Formula 3, Ar¹, Ar², and Ar³ each independently represent a phenylene group, a naphthylene group, or a biphenylylene group.

<16> A laminate including the film according to any one of <1> to <15>; and a metal layer disposed on at least one surface of the film.

<17> The laminate according to <16>, in which a surface asperity of the metal layer on a side in contact with the film is 0.5 μm or less.

According to an embodiment of the present disclosure, it is possible to provide a film in which curling is suppressed.

Further, according to another aspect of the present disclosure, it is possible to provide a laminate formed of the film.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present specification, a numerical range shown using “to” indicates a range including numerical values described before and after “to” as a lower limit value and an upper limit value.

In a numerical range described in a stepwise manner in the present disclosure, an upper limit value or a lower limit value described in one numerical range may be replaced with an upper limit or a lower limit in another numerical range described in a stepwise manner. In addition, in a numerical range described in the present disclosure, an upper limit value or a lower limit value described in the numerical range may be replaced with a value described in an example.

In addition, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

Further, the term “step” in the present specification indicates not only an independent step but also a step which cannot be clearly distinguished from other steps as long as the intended purpose of the step is achieved.

Further, in the present disclosure, “% by mass” has the same definition as that for “% by weight”, and “part by mass” has the same definition as that for “part by weight”.

Furthermore, in the present disclosure, a combination of two or more preferred embodiments is a more preferred embodiment.

In addition, the weight-average molecular weight (Mw) and the number-average molecular weight (Mn) in the present disclosure are molecular weights in terms of polystyrene used as a standard substance, which are detected by using a solvent tetrahydrofuran (THF), a differential refractometer, and a gel permeation chromatography (GPC) analyzer using TSKgel GMHxL, TSKgel G4000HxL, and TSKgel G2000HxL (all trade names manufactured by Tosoh Corporation) as columns, unless otherwise specified.

Hereinafter, the present disclosure will be described in detail.

### [Film]

A first aspect of a film according to the present disclosure is a film including a phase-separated structure having at least two phases, in which in a case where a glass transition temperature of a first phase is denoted by Tg1, a second phase does not have an inflection point of a storage elastic modulus in a temperature range of 25° C. or higher and the Tg1 or lower.

A second aspect of a film according to the present disclosure is a film including a phase-separated structure having at least two phases, in which in a case where a glass transition temperature of a first phase is denoted by Tg1, a melting point of a second phase is higher than the Tg1.

A third aspect of a film according to the present disclosure is a film including a phase-separated structure having at least two phases, in which in a case where a glass transition temperature of a first phase is denoted by Tg1, a storage elastic modulus of a second phase at a temperature higher than the Tg1 by 25° C. is 0.5 times or more a storage elastic modulus at a temperature lower than the Tg1 by 25° C.

In the film according to the embodiment of the present disclosure, the first phase is one of at least two phases, the second phase is one of the at least two phases, and the second phase is a phase different from the first phase.

The film according to the embodiment of the present disclosure may further have a phase different from the first phase and the second phase.

The present inventors have found that the film in the related art may be curled.

In the present disclosure, the term “curled” means that the shape of the film in a case of being viewed from a direction parallel to the main surface of the film is annular or arcuate.

As a result of intensive studies, the present inventors have found that a film having suppressed curling can be provided by adopting the above-described configuration.

In the first aspect of the film according to the embodiment of the present disclosure, in a case where the glass transition temperature of the first phase is denoted by Tg1, the second phase does not have an inflection point of a storage elastic modulus in a temperature range of 25° C. or higher and Tg1 or lower. In a case where the first phase is solidified in a temperature range of 25° C. or higher and Tg1 or lower in the film manufacturing process, the shrinkage of the second phase is suppressed, and thus the curling of the film is suppressed.

In the second aspect of the film according to the embodiment of the present disclosure, in a case where the glass transition temperature of the first phase is denoted by Tg1, a melting point of the second phase is higher than Tg1. In a case where the first phase is solidified in a temperature range of Tg1 or lower in the film manufacturing process, the shrinkage of the second phase is suppressed, and thus the curling of the film is suppressed.

In the film of the third aspect according to the embodiment of the present disclosure, in a case where the glass transition temperature of the first phase is denoted by Tg1, the storage elastic modulus of the second phase at a temperature higher than Tg1 by 25° C. is 0.5 times or more the storage elastic modulus of the second phase at a temperature lower than Tg1 by 25° C. Generally, as the temperature is higher, the storage elastic modulus tends to be lower. However, the second phase has a small change in storage elastic modulus at a temperature higher than Tg1 by 25° C. and a temperature lower than Tg1 by 25° C. Therefore, in a case where the first phase is solidified in a temperature range of Tg1 or lower in the film manufacturing process, the shrinkage of the second phase is suppressed, and thus the curling of the film is suppressed.

On the other hand, JP2021-30631A does not describe the storage elastic modulus or the melting point.

Hereinafter, the configuration common to the first aspect, the second aspect, and the third aspect of the film according to the embodiment of the present disclosure will be simply described as “film of the embodiment of the present disclosure”.

### <Phase-Separated Structure>

The film according to the embodiment of the present disclosure has a phase-separated structure including at least two phases. In the present disclosure, the “phase-separated structure” means a structure in which at least two portions containing components different from each other are present in the film.

Examples of the phase-separated structure include a sea-island structure, a co-continuous structure, a cylinder structure, and a lamella structure. The sea-island structure means a structure in which one phase of at least two phases forms a continuous phase and the other phase is present in a state of being discontinuously dispersed (that is, the other phase forms a dispersed phase). In addition, the co-continuous structure means a structure in which all of the at least two phases form a continuous phase. The cylinder structure means a structure having, in at least one phase of the at least two phases, a plurality of rod-like phases which are other phases. The lamella structure means a layered structure in which the at least two phases are alternately overlapped. Both the cylinder structure and the lamella structure are structures in which all of the at least two phases form a continuous phase, but they are distinguished from the co-continuous structure in that they have the above-described characteristics (rod-like or layered).

The phase-separated structure in the film according to the embodiment of the present disclosure is preferably a sea-island structure. In the sea-island structure, it is preferable that the first phase is a continuous phase and the second phase is a dispersed phase.

The fact that the film has a phase-separated structure can be confirmed by a method of observing a morphology, evaluating a material distribution, evaluating a mechanical property distribution, or the like for the film surface, the film cross section, or both the film surface and the film cross section. The morphology observation can be performed using a known optical microscope, an electron microscope, or the like. The material distribution evaluation can be performed using imaging such as infrared spectroscopy, Raman spectroscopy, and an X-ray photoelectron spectroscopy apparatus. The evaluation of the mechanical property distribution can be performed using an atomic force microscope.

The film according to the embodiment of the present disclosure is manufactured, for example, by applying a dispersion liquid including a polymer and polymer particles onto a substrate, drying the dispersion liquid, and then performing an annealing treatment. By the annealing treatment, at least a part of the polymer particles is melted, and the polymer particles are linked to each other, whereby a phase-separated structure including a first phase derived from the polymer and a second phase derived from the polymer particles is formed. Details of the method of producing the film according to the embodiment of the present disclosure will be described later.

### <Dielectric Loss Tangent>

From the viewpoint of reducing transmission loss, in the film according to the embodiment of the present disclosure, the dielectric loss tangent is preferably 0.010 or less, more preferably 0.005 or less, and still more preferably greater than 0 and 0.003 or less.

In the present disclosure, the dielectric loss tangent is measured by the following method. The dielectric loss tangent is measured by a resonance perturbation method at a frequency of 10 GHz. A 10 GHz cavity resonator (CP531 of Kanto Electronics Application & Development Inc.) is connected to a network analyzer (“E8363B” manufactured by Agilent Technology), and a measurement sample (width: 2.0 mm×length: 80 mm) is inserted into the cavity resonator, and the dielectric loss tangent of the measurement sample is measured based on a change in resonance frequency for 96 hours before and after the insertion in an environment of a temperature of 25° C. and a humidity of 60% RH.

### <Degree of Crystallinity>

From the viewpoint of flexibility of the film, in the film according to the embodiment of the present disclosure, the degree of crystallinity is preferably 80% or less, more preferably 70% or less, and still more preferably 60% or less. The lower limit value of the degree of crystallinity is not particularly limited, and is, for example, 1%.

In the present disclosure, the degree of crystallinity is measured by the following method.

X-ray diffraction (XRD) measurement is performed on the film, and a ratio of a peak area of a crystal component to a total peak area of the obtained profile is defined as a degree of crystallinity. The XRD measurement is performed at 25° C.

### <Glass Transition Temperature>

From the viewpoint of thermal stability, in the film according to the embodiment of the present disclosure, the glass transition temperature is preferably 100° C. to 200° C., more preferably 130° C. to 200° C., and still more preferably 150° C. to 200° C.

In the present disclosure, the glass transition temperature is measured using a differential scanning calorimetry (DSC) device.

From the viewpoint of strength, an average thickness of the film according to the embodiment of the present disclosure is preferably 6 μm to 200 μm, more preferably 12 μm to 100 μm, and particularly preferably 20 μm to 60 μm.

The average thickness of the film is measured at optional (random) five sites using an adhesive film thickness meter, for example, an electronic micrometer (product name, “KG3001A”, manufactured by Anritsu Corporation), and the average value of the measured values is defined as the average thickness of the film.

### <First Phase>

It is preferable that the film according to the embodiment of the present disclosure has a phase-separated structure including at least two phases, and a first phase which is one of the at least two phases contains at least one polymer.

The type of the polymer is not particularly limited, and a known polymer can be used.

Examples of the polymer include thermoplastic resins such as a liquid crystal polymer, a fluororesin, a polymerized substance of a compound which has a cyclic aliphatic hydrocarbon group and a group having an ethylenically unsaturated bond, polyether ether ketone, polyolefin, polyamide, polyester, polyphenylene sulfide, polyether ketone, polycarbonate, polyethersulfone, polyphenylene ether and a modified product thereof, and polyetherimide; elastomers such as a copolymer of glycidyl methacrylate and polyethylene; and thermosetting resins such as a phenol resin, an epoxy resin, a polyimide resin, and a cyanate resin.

Among these, from the viewpoint of reducing the dielectric loss tangent of the film, the first phase preferably includes at least one polymer selected from the group consisting of a liquid crystal polymer, a fluororesin, a polymer of a compound having a cyclic aliphatic hydrocarbon group and a group having an ethylenically unsaturated bond, and a polyphenylene ether, more preferably includes at least one polymer selected from the group consisting of a liquid crystal polymer and a fluororesin, still more preferably includes a liquid crystal polymer from the viewpoint of film forming properties and mechanical strength, and particularly preferably includes a fluororesin from the viewpoint of the dielectric loss tangent.

### —Liquid Crystal Polymer—

The type of the liquid crystal polymer is not particularly limited, and a known liquid crystal polymer can be used.

In addition, the liquid crystal polymer may be a thermotropic liquid crystal polymer which exhibits liquid crystallinity in a molten state, or may be a lyotropic liquid crystal polymer which exhibits liquid crystallinity in a solution state. In addition, in a case of the thermotropic liquid crystal, it is preferable that the liquid crystal is melted at a temperature of 450° C. or lower.

Examples of the liquid crystal polymer include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

In addition, as the liquid crystal polymer, from the viewpoint of liquid crystallinity, a polymer having an aromatic ring is preferable, and an aromatic polyester or an aromatic polyester amide is more preferable.

Furthermore, the liquid crystal polymer may be a polymer in which an imide bond, a carbodiimide bond, a bond derived from an isocyanate, such as an isocyanurate bond, or the like is further introduced into the aromatic polyester or the aromatic polyester amide.

In addition, it is preferable that the liquid crystal polymer is a wholly aromatic liquid crystal polymer formed of only an aromatic compound as a raw material monomer.

Examples of the liquid crystal polymer include the following liquid crystal polymers.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine;
2) a liquid crystal polymer obtained by polycondensing a plurality of types of aromatic hydroxycarboxylic acids;
3) a liquid crystal polymer obtained by polycondensing (i) an aromatic dicarboxylic acid and (ii) at least one compound selected from the group consisting of an aromatic diol, an aromatic hydroxyamine, and an aromatic diamine;
4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid, an aromatic diol, and an aromatic hydroxyamine, include a derivative (acylated product) obtained by acylating a hydroxy group and converting the acylated group into an acyloxy group.

For example, the aromatic hydroxycarboxylic acid, the aromatic diol, and the aromatic hydroxyamine can be each replaced with an acylated product by acylating a hydroxy group and converting the acylated group into an acyloxy group.

Examples of a polymerizable derivative of a compound having an amino group, such as an aromatic hydroxyamine or an aromatic diamine, include a derivative (acylated product) obtained by acylating an amino group and converting the acylated group to an acylamino group.

For example, the aromatic hydroxyamine and the aromatic diamine can be each replaced with an acylated product by acylating an amino group and converting the acylated group into an acylamino group.

The liquid crystal polymer preferably has crystallinity (for example, aromatic polyester amide described later). In a case where the liquid crystal polymer contained in the first phase has crystallinity, the dielectric loss tangent is further reduced.

A melting point of the liquid crystal polymer is preferably equal to or higher than 250° C., more preferably 250° C. to 350° C., and still more preferably 260° C. to 330° C.

In the present disclosure, the melting point is measured using a differential scanning calorimetry device.

The weight-average molecular weight of the liquid crystal polymer is preferably equal to or less than 1,000,000, more preferably 3,000 to 300,000, still more preferably 5,000 to 100,000, and particularly preferably 5,000 to 30,000.

The liquid crystal polymer preferably includes aromatic polyester amide from a viewpoint of further decreasing the dielectric loss tangent. Aromatic polyester amide is resin having at least one aromatic ring and having an ester bond and an amide bond. Aromatic polyester amide included in a resin layer is preferably fully aromatic polyester amide among the substances from a viewpoint of heat resistance.

Aromatic polyester amide preferably contains a constitutional unit represented by Formula 1, a constitutional unit represented by Formula 2, and a constitutional unit represented by Formula 3.

—O—Ar¹—CO— Formula 1

—CO—Ar²—CO— Formula 2

—NH—Ar³—O— Formula 3

In Formula 1 to Formula 3, Ar¹, Ar², and Ar³ each independently represent a phenylene group, a naphthylene group, or a biphenylylene group.

Hereinafter, the constitutional unit represented by Formula 1 and the like are also referred to as “unit 1” and the like.

The unit 1 can be introduced, for example, using aromatic hydroxycarboxylic acid as a raw material.

The unit 2 can be introduced, for example, using aromatic dicarboxylic acid as a raw material.

The unit 3 can be introduced, for example, using aromatic hydroxylamine as a raw material.

Here, the aromatic hydroxycarboxylic acid, the aromatic dicarboxylic acid, the aromatic diol, and the aromatic hydroxylamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid and an aromatic hydroxyamine, include a derivative (acylated product) obtained by acylating a hydroxy group and converting the acylated group into an acyloxy group.

For example, the aromatic hydroxycarboxylic acid and the aromatic hydroxylamine can be each replaced with an acylated product by acylating a hydroxy group and converting the acylated group into an acyloxy group.

Examples of a polycondensable derivative of the aromatic hydroxylamine include a substance (acylated product) obtained by acylating an amino group to convert the amino group into an acylamino group.

For example, the aromatic hydroxyamine can be replaced with an acylated product by acylating an amino group and converting the acylated group into an acylamino group.

In Formula 1, Ar¹ is preferably a p-phenylene group, a 2,6-naphthylene group, or a 4,4′-biphenylylene group, and more preferably a 2,6-naphthylene group.

In a case where Ar¹ is a p-phenylene group, the unit 1 is, for example, a constitutional unit derived from p-hydroxybenzoic acid.

In a case where Ar¹ is a 2,6-naphthylene group, the unit 1 is, for example, a constitutional unit derived from 6-hydroxy-2-naphthoic acid.

In a case where Ar¹ is a 4,4′-biphenylylene group, the unit 1 is, for example, a constitutional unit derived from 4′-hydroxy-4-biphenylcarboxylic acid.

In Formula 2, Ar² is preferably a p-phenylene group, an m-phenylene group, or a 2,6-naphthylene group, and more preferably an m-phenylene group.

In a case where Ar² is a p-phenylene group, the unit 2 is, for example, a constitutional unit derived from terephthalic acid.

In a case where Ar² is an m-phenylene group, the unit 2 is, for example, a constitutional unit derived from isophthalic acid.

In a case where Ar² is a 2,6-naphthylene group, the unit 2 is, for example, a constitutional unit derived from 2,6-naphthalenedicarboxylic acid.

In Formula 3, Ar³ is preferably a p-phenylene group or a 4,4′-biphenylylene group, and more preferably a p-phenylene group.

In a case where Ar³ is a p-phenylene group, the unit 3 is, for example, a constitutional unit derived from p-aminophenol.

In a case where Ar³ is a 4,4′-biphenylylene group, the unit 3 is, for example, a constitutional unit derived from 4-amino-4′-hydroxybiphenyl.

With respect to the total content of the unit 1, the unit 2, and the unit 3, a content of the unit 1 is preferably 30 mol % or more, a content of the unit 2 is preferably 35% or less, and a content of the unit 3 is preferably 35 mol % or less.

The content of the unit 1 is preferably 30 mol % to 80 mol %, more preferably 30 mol % to 60 mol %, and particularly preferably 30 mol % to 40 mol % with respect to the total content of the unit 1, the unit 2, and the unit 3.

The content of the unit 2 is preferably 10 mol % to 35 mol %, more preferably 20 mol % to 35 mol %, and particularly preferably 30 mol % to 35 mol % with respect to the total content of the unit 1, the unit 2, and the unit 3.

The content of the unit 3 is preferably 10 mol % to 35 mol %, more preferably 20 mol % to 35 mol %, and particularly preferably 30 mol % to 35 mol % with respect to the total content of the unit 1, the unit 2, and the unit 3.

The total content of the constitutional units is a value obtained by totaling a substance amount (mol) of each constitutional unit. The substance amount of each constitutional unit is calculated by dividing a mass of each constitutional unit constituting aromatic polyester amide by a formula weight of each constitutional unit.

In a case where a ratio of the content of the unit 2 to the content of the unit 3 is expressed as [Content of unit 2]/[Content of unit 3] (mol/mol), the ratio is preferably 0.9/1 to 1/0.9, more preferably 0.95/1 to 1/0.95, and still more preferably 0.98/1 to 1/0.98.

Aromatic polyester amide may have two kinds or more of the unit 1 to the unit 3 each independently. Alternatively, aromatic polyester amide may have other constitutional units other than the unit 1 to the unit 3. A content of other constitutional units is preferably 10% by mole or less and more preferably 5% by mole or less with respect to the total content of all constitutional units.

Aromatic polyester amide is preferably produced by subjecting a source monomer corresponding to the constitutional unit constituting the aromatic polyester amide to melt polymerization.

The first phase may include only one or two or more kinds of aromatic polyester amides.

A content of aromatic polyester amide is preferably equal to or greater than 50% by mass, more preferably equal to or greater than 70% by mass, and still more preferably equal to or greater than 90% by mass, with respect to a total amount of the first phase. An upper limit value of the content of aromatic polyester amide is not particularly limited, and may be 100% by mass.

It is preferable that the liquid crystal polymer is produced by melt-polymerizing raw material monomers corresponding to the constitutional units constituting the liquid crystal polymer. The melt polymerization may be carried out in the presence of a catalyst, examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole, and nitrogen-containing heterocyclic compounds are preferably used. The melt polymerization may be further carried out by solid phase polymerization as necessary.

A flow start temperature of the liquid crystal polymer is preferably 250° C. or higher, more preferably 250° C. or higher and 350° C. or lower, and still more preferably 260° C. or higher and 330° C. or lower. In a case where the flow start temperature of the liquid crystal polymer is within the above-described range, the solubility, the heat resistance, the strength, and the rigidity are excellent, and the viscosity of the solution is appropriate.

The flow start temperature, also referred to as a flow temperature, is a temperature at which a viscosity of 4,800 Pa-s (48,000 poises) is exhibited in a case where the liquid crystal polymer is melted and extruded from a nozzle having an inner diameter of 1 mm and a length of 10 mm while the temperature is raised at a rate of 4° C./min under a load of 9.8 MPa (100 kg/cm²) using a capillary rheometer and is a guideline for the molecular weight of the liquid crystal polymer (see p. 95 of “Liquid Crystal Polymers—Synthesis/Molding/Applications—”, written by Naoyuki Koide, CMC Corporation, Jun. 5, 1987).

### —Fluororesin—

In the present disclosure, the type of the fluororesin is not particularly limited, and a known fluororesin can be used.

Examples of the fluororesin include a homopolymer and a copolymer containing a constitutional unit derived from a fluorinated α-olefin monomer, that is, an α-olefin monomer containing at least one fluorine atom. In addition, examples of the fluororesin include a copolymer containing a constitutional unit derived from a fluorinated α-olefin monomer, and a constitutional unit derived from a non-fluorinated ethylenically unsaturated monomer reactive to the fluorinated α-olefin monomer.

Examples of the fluorinated α-olefin monomer include CF₂═CF₂, CHF═CF₂, CH₂═CF₂, CHCl═CHF, CClF═CF₂, CCl₂═CF₂, CClF═CClF, CHF═CCl₂, CH₂═CClF, CCL₂=CClF, CF₃CF═CF₂, CF₃CF═CHF, CF₃CH═CF₂, CF₃CH═CH₂, CHF₂CH═CHF, CF₃CF═CF₂, and perfluoro(alkyl having 2 to 8 carbon atoms) vinyl ether (for example, perfluoromethyl vinyl ether, perfluoropropyl vinyl ether, and perfluorooctyl vinyl ether). Among these, as the fluorinated α-olefin monomer, at least one monomer selected from the group consisting of tetrafluoroethylene (CF₂═CF₂), chlorotrifluoroethylene (CClF═CF₂), (perfluorobutyl)ethylene, vinylidene fluoride (CH₂═CF₂), and hexafluoropropylene (CF₂═CFCF₃) is preferable.

Examples of the non-fluorinated ethylenically unsaturated monomer include ethylene, propylene, butene, and an ethylenically unsaturated aromatic monomer (for example, styrene and α-methylstyrene).

The fluorinated α-olefin monomer may be used alone or in combination of two or more thereof.

In addition, the non-fluorinated ethylenically unsaturated monomer may be used alone or in combination of two or more thereof.

Examples of the fluororesin include polychlorotrifluoroethylene (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (FEP), poly(tetrafluoroethylene-propylene) (FEPM), poly(tetrafluoroethylene-perfluoropropylene vinyl ether), poly(tetrafluoroethylene-perfluoroalkyl vinyl ether) (PFA) (for example, poly(tetrafluoroethylene-perfluoropropyl vinyl ether)), polyvinyl fluoride (PVF), polyvinylidene fluoride (PVDF), poly(vinylidene fluoride-chlorotrifluoroethylene), perfluoropolyether, perfluorosulfonic acid, and perfluoropolyoxetane.

The fluororesin may have a constitutional unit derived from fluorinated ethylene or fluorinated propylene.

The fluororesin may be used alone or in combination of two or more thereof.

The fluororesin is preferably FEP, PFA, ETFE, or PTFE.

The FEP is available from Du Pont as the trade name of TEFLON (registered trademark) FEP or from DAIKIN INDUSTRIES, LTD. as the trade name of NEOFLON FEP. The PFA is available from DAIKIN INDUSTRIES, LTD. as the trade name of NEOFLON PFA, from Du Pont as the trade name of TEFLON (registered trademark) PFA, or from Solvay Solexis as the trade name of HYFLON PFA.

The fluororesin more preferably includes PTFE. The PTFE may be a PTFE homopolymer, a partially modified PTFE homopolymer, or a combination including one or both of these. The partially modified PTFE homopolymer preferably contains a constitutional unit derived from a comonomer other than tetrafluoroethylene in an amount of less than 1% by mass based on the total mass of the polymer.

The fluororesin may be a crosslinkable fluoropolymer having a crosslinkable group. The crosslinkable fluoropolymer can be crosslinked by a known crosslinking method in the related art. One of the representative crosslinkable fluoropolymers is a fluoropolymer having (meth)acryloyloxy. For example, the crosslinkable fluoropolymer can be represented by Formula: H₂C═CR′COO—(CH₂)ₙ—R—(CH₂)ₙ—OOCR′═CH₂.

In the formula, R is an oligomer chain having a constitutional unit derived from the fluorinated α-olefin monomer, R′ is H or —CH₃, and n is 1 to 4. R may be a fluorine-based oligomer chain having a constitutional unit derived from tetrafluoroethylene.

In order to initiate a radical crosslinking reaction through the (meth)acryloyloxy group in the fluororesin, by exposing the fluoropolymer having a (meth)acryloyloxy group to a free radical source, a crosslinked fluoropolymer network can be formed. The free radical source is not particularly limited, and suitable examples thereof include a photoradical polymerization initiator and an organic peroxide. Appropriate photoradical polymerization initiators and organic peroxides are well known in the art. The crosslinkable fluoropolymer is commercially available, and examples thereof include Viton B manufactured by Du Pont.

—Polymerized Substance of Compound which has Cyclic Aliphatic Hydrocarbon Group and Group Having Ethylenically Unsaturated Bond—

Examples of the polymerized substance of a compound which has a cyclic aliphatic hydrocarbon group and a group having an ethylenically unsaturated bond include thermoplastic resins having a constitutional unit derived from a cyclic olefin monomer such as norbornene and a polycyclic norbornene-based monomer.

The polymerized substance of a compound which has a cyclic aliphatic hydrocarbon group and a group having an ethylenically unsaturated bond may be a ring-opened polymer of the above-described cyclic olefin, a hydrogenated product of a ring-opened copolymer using two or more cyclic olefins, or an addition polymer of a cyclic olefin and a linear olefin or aromatic compound having an ethylenically unsaturated bond such as a vinyl group. In addition, a polar group may be introduced into the polymerized substance of a compound which has a cyclic aliphatic hydrocarbon group and a group having an ethylenically unsaturated bond.

The polymerized substance of a compound which has a cyclic aliphatic hydrocarbon group and a group having an ethylenically unsaturated bond may be used alone or in combination of two or more thereof.

A ring structure of the cyclic aliphatic hydrocarbon group may be a single ring, a fused ring in which two or more rings are fused, or a crosslinked ring.

Examples of the ring structure of the cyclic aliphatic hydrocarbon group include a cyclopentane ring, a cyclohexane ring, a cyclooctane ring, an isophorone ring, a norbornane ring, and a dicyclopentane ring.

The compound which has a cyclic aliphatic hydrocarbon group and a group having an ethylenically unsaturated bond is not particularly limited, and examples thereof include a (meth)acrylate compound having a cyclic aliphatic hydrocarbon group, a (meth)acrylamide compound having a cyclic aliphatic hydrocarbon group, and a vinyl compound having a cyclic aliphatic hydrocarbon group. Among these, preferred examples thereof include a (meth)acrylate compound having a cyclic aliphatic hydrocarbon group. In addition, the compound which has a cyclic aliphatic hydrocarbon group and a group having an ethylenically unsaturated bond may be a monofunctional ethylenically unsaturated compound or a polyfunctional ethylenically unsaturated compound.

The number of cyclic aliphatic hydrocarbon groups in the compound which has a cyclic aliphatic hydrocarbon group and a group having an ethylenically unsaturated bond may be 1 or more, and may be 2 or more.

It is sufficient that the polymerized substance of a compound which has a cyclic aliphatic hydrocarbon group and a group having an ethylenically unsaturated bond is a polymer obtained by polymerizing at least one compound which has a cyclic aliphatic hydrocarbon group and a group having an ethylenically unsaturated bond, and it may be a polymerized substance of two or more kinds of the compound which has a cyclic aliphatic hydrocarbon group and a group having an ethylenically unsaturated bond or a copolymer with other ethylenically unsaturated compounds having no cyclic aliphatic hydrocarbon group.

In addition, the polymerized substance of a compound which has a cyclic aliphatic hydrocarbon group and a group having an ethylenically unsaturated bond is preferably a cycloolefin polymer.

### —Polyphenylene Ether—

In the polyphenylene ether, from the viewpoint of dielectric loss tangent and heat resistance, the average number of molecular terminal phenolic hydroxyl groups per molecule (the number of terminal hydroxyl groups) is preferably 1 to 5 and more preferably 1.5 to 3.

The number of terminal hydroxyl groups in the polyphenylene ether can be found, for example, from a standard value of a product of the polyphenylene ether. In addition, the number of terminal hydroxyl groups is expressed as, for example, an average value of the number of phenolic hydroxyl groups per molecule of all polyphenylene ethers present in 1 mol of the polyphenylene ether.

The polyphenylene ether may be used alone or in combination of two or more thereof.

Examples of the polyphenylene ether include a polyphenylene ether including 2,6-dimethylphenol and at least one of bifunctional phenol or trifunctional phenol, and poly(2,6-dimethyl-1,4-phenylene oxide). More specifically, the polyphenylene ether is preferably a compound having a structure represented by Formula (PPE).

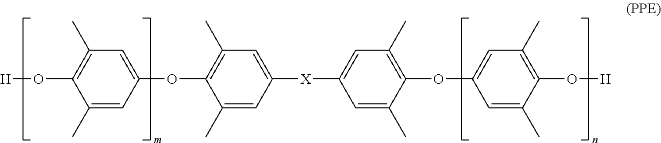

In Formula (PPE), X represents an alkylene group having 1 to 3 carbon atoms or a single bond, m represents an integer of 0 to 20, n represents an integer of 0 to 20, and the sum of m and n represents an integer of 1 to 30.

Examples of the alkylene group in X described above include a dimethylmethylene group.

In a case where heat curing is performed after film formation, from the viewpoint of heat resistance and film-forming property, a weight-average molecular weight (Mw) of the polyphenylene ether is preferably 500 to 5,000 and preferably 500 to 3,000. In addition, in a case where the heat curing is not performed, the weight-average molecular weight (Mw) of the polyphenylene ether is not particularly limited, but is preferably 3,000 to 100,000 and preferably 5,000 to 50,000.

### —Aromatic Polyether Ketone—

The aromatic polyether ketone is not particularly limited, and a known aromatic polyether ketone can be used.

The aromatic polyether ketone is preferably a polyether ether ketone.

The polyether ether ketone is one type of the aromatic polyether ketone, and is a polymer in which bonds are arranged in the order of an ether bond, an ether bond, and a carbonyl bond. It is preferable that the bonds are linked to each other by a divalent aromatic group.

The aromatic polyether ketone may be used alone or in combination of two or more thereof.

Examples of the aromatic polyether ketone include polyether ether ketone (PEEK) having a chemical structure represented by Formula (P1), polyether ketone (PEK) having a chemical structure represented by Formula (P2), polyether ketone ketone (PEKK) having a chemical structure represented by Formula (P3), polyether ether ketone ketone (PEEKK) having a chemical structure represented by Formula (P4), and polyether ketone ether ketone ketone (PEKEKK) having a chemical structure represented by Formula (P5).

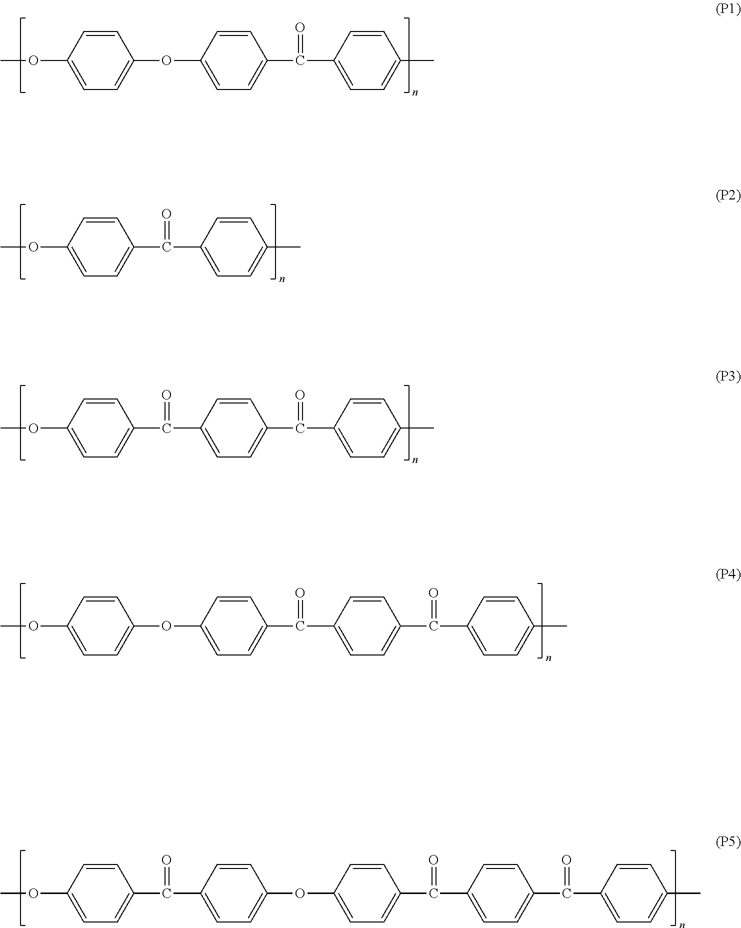

From the viewpoint of mechanical properties, each n of Formulae (P1) to (P5) is preferably 10 or more and more preferably 20 or more. On the other hand, from the viewpoint that the aromatic polyether ketone can be easily produced, n is preferably 5,000 or less and more preferably 1,000 or less. That is, n is preferably 10 to 5,000 and more preferably 20 to 1,000.

The first phase may contain components other than the polymer as long as the effects of the present disclosure are not significantly impaired.

Known additives can be used as other components. Examples of the other components include a leveling agent, an antifoaming agent, an antioxidant, an ultraviolet absorbing agent, a flame retardant, and a colorant.

From the viewpoint of suppressing the dielectric loss tangent of the film, the content of the first phase is preferably 55% by mass or less and more preferably 20% by mass to 35% by mass with respect to the total mass of the film.

From the viewpoint of thermal stability of the film, the glass transition temperature (Tg1) of the first phase is preferably 100° C. to 200° C. and more preferably 150° C. to 200° C. A measuring method of the glass transition temperature is as described above.

### <Second Phase>

It is preferable that the film according to the embodiment of the present disclosure has a phase-separated structure including at least two phases, and a second phase which is one of the at least two phases and different from the first phase preferably includes at least one polymer.

The second phase may satisfy any or at least one of the following conditions with respect to the glass transition temperature Tg1 of the first phase, and the type of the polymer that may be included in the second phase is not particularly limited.
(1) An inflection point of a storage elastic modulus is not included in a temperature range of 25° C. or higher and Tg1 or lower.
(2) The melting point is higher than the Tg1.
(3) The storage elastic modulus at a temperature higher than Tg1 by 25° C. is 0.5 times or more the storage elastic modulus at a temperature lower than Tg1 by 25° C.

Examples of the polymer include a liquid crystal polymer, polyethylene, polystyrene, urea-formalin filler, polyester, cellulose, acrylic resin, fluororesin, cured epoxy resin, crosslinked benzoguanamine resin, and crosslinked acrylic resin.

From the viewpoint of suppressing curling of the film, the storage elastic modulus of the second phase at 25° C. is preferably 10 GPa or less and more preferably 3.5 GPa or less. The lower limit value of the storage elastic modulus is not particularly limited, and is, for example, 0.1 GPa.

In the present disclosure, the stored elastic modulus is measured by the following method.

A sample for evaluating a cross section was produced by embedding the film in a UV resin and cutting the film with a microtome. Using a scanning probe microscope (product name “SPA400”, manufactured by SII NanoTechnology Inc.), a cross section exposed by the above-described cutting is observed in a VE-AFM mode, and a storage elastic modulus of the second phase at 25° C. is measured. For example, in a case where the film has a sea-island structure, the dispersed phase is specified as a second phase, and the storage elastic modulus is measured.

From the viewpoint of the temperature at which the annealing treatment is performed, the melting point of the second phase is preferably 500° C. or lower and more preferably 400° C. or lower. The lower limit value of the melting point is not particularly limited, but is preferably 300° C. The method for measuring the melting point is as described above.

From the viewpoint of reducing transmission loss, the dielectric loss tangent of the second phase is preferably 0.002 or less, more preferably 0.0015 or less, and still more preferably greater than 0 and 0.001 or less. It is preferable that the dielectric loss tangent of the second phase is less than the dielectric loss tangent of the film.

The second phase preferably includes particles and more preferably includes polymer particles. The fact that the second phase includes particles can be confirmed by using means such as a morphology observation, a material distribution evaluation, and a mechanical property distribution evaluation for a film surface, a film cross section, or both of the film surface and the cross section.

The shape of the particles is not particularly limited, and examples thereof include a spherical shape, a spindle shape, a prismatic shape, a cylindrical shape, a flat plate shape, and an amorphous shape.

From the viewpoint of suppressing curling of the film, an average particle diameter of the particles is preferably 5 nm to 20 μm, more preferably 0.1 μm to 20 μm, and still more preferably 5 μm to 20 μm.

The average particle diameter is a particle diameter (D50) at which the volume accumulated from the small diameter side is 50% in the volume-based particle size distribution. D50 can be measured using a scanning electron microscope (SEM).

From the viewpoint of suppressing the dielectric loss tangent of the film, the content of the second phase is preferably 45% by mass or more and more preferably 65% by mass to 80% by mass with respect to the total mass of the film.

Hereinafter, the configurations other than the common configurations of the first to third aspects of the film according to the embodiment of the present disclosure will be described.

### (First Aspect)

In the first aspect of the film according to the embodiment of the present disclosure, in a case where the glass transition temperature of the first phase is denoted by Tg1, the second phase does not have an inflection point of a storage elastic modulus in a temperature range of 25° C. or higher and Tg1 or lower.

That is, in a case where the second phase does not have an inflection point of the storage elastic modulus or in a case where the second phase has an inflection point of the storage elastic modulus, the temperature indicating the inflection point of the storage elastic modulus is lower than 25° C. or higher than Tg1.

The inflection point is a point where the shape of a continuous curve changes, and refers to a point where the inclination of a tangent line of the curve changes. For example, this means a point where the inclination of the curve changes from an increase to a decrease (or from a decrease to an increase), a point where the shape of the curve changes from a concave shape to a convex shape (or from a convex shape to a concave shape), and the like.

The temperature indicating the inflection point of the storage elastic modulus is a temperature at which the inflection point is obtained in a curve obtained by scanning the temperature from a low temperature side to a high temperature side to measure the storage elastic modulus and plotting the temperature on the lateral axis and the storage elastic modulus on the vertical axis. The method of measuring the storage elastic modulus is as described above.

Among these, it is preferable that the temperature indicating the inflection point of the storage elastic modulus in the second phase is a temperature higher than Tg1. Specifically, in the second phase, the temperature indicating the inflection point of the storage elastic modulus is preferably 200° C. or higher and more preferably 300° C. or higher. An upper limit value of the temperature indicating the inflection point of the storage elastic modulus is not particularly limited, and is, for example, 5000° C.

From the viewpoint of further suppressing the curling of the film, the absolute value of the difference between the temperature indicating the inflection point of the storage elastic modulus in the second phase and Tg1 is preferably 50° C. or higher and more preferably 150° C. or higher. The upper limit value of the absolute value of the difference is not particularly limited and is, for example, 5000° C.

In the first aspect, since the second phase does not have an inflection point of a storage elastic modulus in a temperature range of 25° C. or higher and Tg1 or lower, in a case where the first phase is solidified in a temperature range of 25° C. or higher and Tg1 or lower in a film manufacturing process, the shrinkage of the second phase is suppressed, and as a result, the curling of the film is suppressed.

### (Second Aspect)

In the second aspect of the film according to the embodiment of the present disclosure, in a case where the glass transition temperature of the first phase is defined as Tg1, the melting point of the second phase is higher than Tg1. The method for measuring the melting point is as described above.

From the viewpoint of further suppressing the curling of the film, the absolute value of the difference between the melting point of the second phase and Tg1 is preferably 50° C. or higher and more preferably 150° C. or higher. The upper limit value of the absolute value of the difference is not particularly limited and is, for example, 5000° C.

In the second aspect, since the melting point of the second phase is higher than Tg1, in a case where the first phase is solidified in a temperature range of Tg1 or lower in the film manufacturing process, the shrinkage of the second phase is suppressed, and as a result, the curling of the film is suppressed.

### (Third Aspect)

In the third aspect of the film according to the embodiment of the present disclosure, in a case where the glass transition temperature of the first phase is denoted by Tg1, the storage elastic modulus of the second phase at a temperature higher than Tg1 by 25° C. is 0.5 times or more the storage elastic modulus of the second phase at a temperature lower than Tg1 by 25° C. The method of measuring the storage elastic modulus is as described above.

In the second phase, a ratio of the storage elastic modulus at a temperature higher than Tg1 by 25° C. to the storage elastic modulus at a temperature lower than Tg1 by 25° C. is preferably 0.6 times or more and more preferably 0.8 times or more. The upper limit value of the above-described ratio is not particularly limited, but is usually less than 1.0 times.

In the third aspect, the second phase has a small change in storage elastic modulus at a temperature that is 25° C. higher than the Tg1 and a temperature that is 25° C. lower than the Tg1. Therefore, in a case where the first phase is solidified in a temperature range of Tg1 or lower in the film manufacturing process, the shrinkage of the second phase is suppressed, and thus the curling of the film is suppressed.

The film according to the embodiment of the present disclosure may have one layer or two or more layers. For example, in a case where a laminate which will be described later is produced using a film, from the viewpoint of improving the adhesiveness between the metal substrate and the film, it is preferable that the film has an adhesive layer.

The film according to the embodiment of the present disclosure can be used for various applications. Among these, the film according to the embodiment of the present disclosure can be suitably used for a film for electronic components such as a printed wiring board, and can be more suitably used for a flexible printed circuit board.

In addition, the film according to the embodiment of the present disclosure can be suitably used as a metal adhesive film.

### [Manufacturing Method of Film]

The film according to the embodiment of the present disclosure is manufactured by a manufacturing method including a step of preparing a dispersion liquid containing a polymer, polymer particles, and a solvent (hereinafter, also referred to as a “dispersion liquid preparation step”), a step of producing a precursor including the dispersion liquid, a substrate, and a cured film of the dispersion liquid formed on the substrate (hereinafter, also referred to as a “precursor production step”), and a step of forming a film on the substrate by performing an annealing treatment on the precursor (hereinafter, also referred to as a “film formation step”).

A film produced by the manufacturing method of the film of the embodiment of the present disclosure has a phase-separated structure including at least two phases.

Hereinafter, each step in an example of the manufacturing method will be described.

### <Dispersion Liquid Preparation Step>

The manufacturing method of the film according to the embodiment of the present disclosure includes a step of preparing a dispersion liquid including a polymer, polymer particles, and a solvent.

The preferred aspect of the polymer prepared in the dispersion liquid preparation step is the same as the preferred aspect of the polymer which may be contained in the first phase.

The preferred aspect of the polymer contained in the polymer particles prepared in the dispersion liquid preparation step is the same as the preferred aspect of the polymer which may be contained in the second phase.

From the viewpoint of obtaining a film having a phase-separated structure including at least two phases, it is preferable that the polymer is dissolved in a solvent contained in the dispersion liquid, and it is preferable that the polymer particles are insoluble in the solvent contained in the dispersion liquid.

It is preferable that the polymer is present in a dissolved state in the solvent in the dispersion liquid, and the polymer particles are present in a dispersed state in a particulate shape without being dissolved in the solvent.

Examples of the solvent contained in the dispersion liquid include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoramide and tri-n-butyl phosphate.

The solvent is preferably a solvent containing, as a main component, an aprotic compound, particularly, an aprotic compound having no halogen atom for low corrosiveness and easiness to handle. A proportion of the aprotic compound to the whole solvent is preferably 50% by mass to 100% by mass, more preferably 70% by mass to 100% by mass, and particularly preferably 90% by mass to 100% by mass. In addition, from the viewpoint of easily dissolving the liquid crystal polymer, as the above-described aprotic compound, an amide such as N,N-dimethylformamide, N,N-dimethylacetamide, tetramethylurea, and N-methylpyrrolidone, or an ester such as γ-butyrolactone is preferable; and N,N-dimethylformamide, N,N-dimethylacetamide, or N-methylpyrrolidone is more preferable.

### (Precursor Production Step)

The manufacturing method of the film according to the embodiment of the present disclosure includes a step of producing a precursor including a substrate and a cured film of the dispersion liquid, which is formed on the substrate.

The type of the substrate is not particularly limited, but in a case where a laminate described later (specifically, a laminate including a film and a metal layer disposed on the film) is assumed to be produced, a metal substrate is preferable. A metal constituting the metal substrate is preferably copper.

A thickness of the substrate is not particularly limited, but is preferably 1 μm to 50 μm and more preferably 5 μm to 25 μm.

In the precursor production step, for example, the dispersion liquid is applied onto the substrate, and then dried. Examples of a method of applying the dispersion liquid include a casting method and a coating method. A drying method is not particularly limited, and the drying may be performed by natural drying or by heating and drying using hot air or the like. The dispersion liquid is dried to remove the solvent, thereby forming a cured film of the dispersion liquid on the substrate. In the cured film of the dispersion liquid, it is preferable that a polymer dissolved in a solvent is present as a matrix, and polymer particles insoluble in the solvent are present in a dispersed state in the matrix.

A thickness of the cured film of the dispersion liquid is not particularly limited, but is preferably 5 μm to 200 μm and more preferably 10 μm to 100 μm.

In the precursor production step, the cured film of the dispersion liquid may be directly formed on a surface of the substrate, or other layers may be provided on the substrate and then the cured film of the dispersion liquid may be formed on a surface of the other layer.

Examples of the other layers include an adhesive layer and a peeling layer. The other layers are appropriately selected according to the purpose.

### (Film Formation Step)

The manufacturing method of the film according to the embodiment of the present disclosure includes a step of forming a film on the substrate by performing an annealing treatment on a precursor. The cured film of the dispersion liquid is heated to form a film.

In the film formation step, the temperature of the annealing treatment is preferably 100° C. to 400° C. In addition, the time of the annealing treatment is preferably 0.1 minutes to 10 hours. The temperature and time of the annealing treatment can be appropriately changed according to the type of the polymer and the polymer particles, and can be lowered or shortened by other means such as adding a catalyst.

From the viewpoint of reducing the dielectric loss tangent, the film formation step is preferably performed in an inert gas atmosphere.

### [Laminate]

The laminate according to the embodiment of the present disclosure may be a laminate including the film according to the present disclosure. The laminate according to the embodiment of the present disclosure preferably includes the polymer film according to the embodiment of the present disclosure, and a layer disposed on at least one surface of the polymer film. The layer disposed on at least one surface of the above-described polymer film is not particularly limited, and examples thereof include a polymer layer and a metal layer. The layer disposed on at least one surface of the polymer film may be a coating layer.

In addition, the layer disposed on at least one surface of the film may be disposed on the entire surface of the film, or may be disposed only on a part of the film.

Among these, the laminate according to the embodiment of the present disclosure preferably has the film according to the present disclosure and a metal layer disposed on at least one surface of the film.

In addition, the metal layer is preferably a copper layer. As the copper foil used for forming the copper layer, a rolled copper foil formed by a rolling method or an electrolytic copper foil formed by an electrolytic method is preferable, and an electrolytic copper foil is more preferable.

A method of attaching the film according to the embodiment of the present disclosure to the metal foil is not particularly limited, and a known laminating method can be used.

In the laminate according to the embodiment of the present disclosure, from the viewpoint of reducing transmission loss, a surface asperity of the metal layer on the side in contact with the film is preferably 0.5 μm or less and more preferably 0.3 μm or less.

In addition, since the smaller surface asperity is preferable, the lower limit value of the surface asperity of the metal layer is not particularly limited, and for example, is 0 μm.

In the present disclosure, the “surface asperity” means a value expressed in micrometers of an average value of the absolute value of the difference in height of each measurement point with respect to the average surface in a reference region.

In the present disclosure, the surface asperity Sa of the metal layer (for example, the copper layer) is measured by the following method.

Using a non-contact surface/layer section shape measuring system VertScan (manufactured by RYOKA SYSTEMS INC.), a surface asperity Sa of an object to be measured is evaluated by measuring a square of 465.48 μm in length and 620.64 μm in width.

An average thickness of the metal layer, preferably the copper layer is not particularly limited, but is preferably 3 μm to 30 μm and more preferably 5 μm to 20 μm. The copper foil may be copper foil with a carrier formed on a support (carrier) so as to be peelable. As the carrier, a known carrier can be used. An average thickness of the carrier is not particularly limited, but is preferably 10 μm to 100 μm and more preferably 18 μm to 50 μm.

It is also preferable that the metal layer in the laminate according to the embodiment of the present disclosure is processed into, for example, a desired circuit pattern by etching to form a flexible printed circuit board. The etching method is not particularly limited, and a known etching method can be used.

### EXAMPLES

Hereinafter, the present disclosure will be described in more detail with reference to examples. The materials, the used amounts, the proportions, the treatment contents, the treatment procedures, and the like described in the following examples can be appropriately changed without departing from the gist of the present disclosure. Therefore, the scope of the present disclosure is not limited to the following specific examples.

### <Synthesis of Aromatic Polyester Amide>

940.9 g (5.0 mol) of 6-hydroxy-2-naphthoic acid, 415.3 g (2.5 mol) of isophthalic acid, 377.9 g (2.5 mol) of acetaminophen, and 867.8 g (8.4 mol) of acetic acid anhydride were added to a reactor provided with a stirrer, a torque meter, a nitrogen gas introduction pipe, a thermometer, and a reflux condenser, the gas inside the reactor was replaced with nitrogen gas, and the mixture was heated from room temperature (23° C.; the same applies hereinafter) to 140° C. over 60 minutes while being stirred in a nitrogen gas stream and was refluxed at 140° C. for 3 hours.

Next, the temperature was raised from 150° C. to 300° C. over 5 hours while distilling off by-produced acetic acid and unreacted acetic acid anhydride, and maintained at 300° C. for 30 minutes. Thereafter, a content is taken out from the reactor and is cooled to the room temperature. The obtained solid was pulverized by a pulverizer to obtain a powdered aromatic polyester amide A1a. A flow start temperature of the aromatic polyester amide A1a was 193° C. In addition, the aromatic polyester amide A1a was a fully aromatic polyester amide.

The aromatic polyester amide A1a was subjected to solid polymerization by increasing the temperature from room temperature to 160° C. over 2 hours and 20 minutes in a nitrogen atmosphere, increasing the temperature from 160° C. to 180° C. over 3 hours and 20 minutes, and maintaining the temperature at 180° C. for 5 hours, and then the resultant was cooled. Next, the resultant was pulverized by a pulverizer to obtain a powdered aromatic polyester amide Alb. A flow start temperature of the aromatic polyester amide A1b was 220° C.

Aromatic polyester amide A1b is subjected to solid polymerization by increasing the temperature from the room temperature to 180° C. over one hour and 25 minutes, next increasing the temperature from 180° C. to 255° C. over six hours and 40 minutes, and maintaining the temperature at 255° C. for five hours under a nitrogen atmosphere, and then, is cooled, and powdered aromatic polyester amide A1 (fully aromatic polyester amide) is obtained.

A flow start temperature of the aromatic polyester amide A1 was 302° C. In addition, in a case where a melting point of the aromatic polyester amide A1 was measured using a differential scanning calorimetry device, the measured value was 311° C.

### <Solution for Forming Layer A>

The above-described aromatic polyester amide A1 (70 g) and N,N-diglycidyl-4-glycidyloxyaniline (0.14 g: B1 in Table 1) as an epoxy compound are mixed, and a solution for forming a layer A containing 97.6% by mass of aromatic polyester amide A1 and 2.4% by mass of the epoxy compound in solid contents is obtained.

### <Solution for Forming Layer B>

### —Preparation of Aromatic Polyester Amide A1 Solution—

The above-described aromatic polyester amide A1 (80 g) was added to 920 g of N-methylpyrrolidone, and stirred at 140° C. for 4 hours in a nitrogen atmosphere. An aromatic polyester amide A1 solution in which the concentration of solid contents was 8.0% by mass was obtained.

### —Polymer Particles—

C1: PTFE particles synthesized by the following method
C2: low-density polyethylene particles (product name “FLO-BEADS CL-2080N”, manufactured by Sumitomo Seika Chemicals Co., Ltd.)

70 L of deionized water was charged into a 150 L stainless steel polymerization tank equipped with a stirring blade and sealed. After removing the air in the tank, 100 g of ethane was charged. Tetrafluoroethylene (TFE) was charged up to the in-tank pressure of 0.5 MPa, and the temperature was raised to 85° C. In a case where the in-tank temperature reached 85° C., TFE was added again, and the in-tank pressure was adjusted to 0.8 MPa. As the polymerization initiator, 250 ppm/H₂O of ammonium persulfate and 250 ppm/H₂O of disuccinic peroxide were charged in a state of an aqueous solution. In a case where the in-tank pressure decreased to 0.7 MPa during the polymerization, the operation of adding TFE to 0.85 MPa was repeated, and the polymerization reaction was terminated at a time point when the TFE supply amount reached 12 kg, and the in-tank pressure was released to atmospheric pressure. After the start of the polymerization reaction, the in-tank temperature was maintained at 84.5° C. to 85.5° C. throughout. The inside of the tank was cooled to room temperature (25° C.), and then the obtained particles were washed with deionized water. The particles were filtered and dried in a hot air circulation type dryer at 170° C. for 12 hours to obtain polytetrafluoroethylene (PTFE) particles.

### —Preparation of Solution for Forming Layer B—

The aromatic polyester amide A1 solution and the polymer particles were mixed such that the aromatic polyester amide A1 and the polymer particles had the contents shown in Table 1, thereby obtaining a solution for forming a layer B.

### Example 1, Example 2, and Comparative Example 1

The solution for a layer A is coated on an electrolytic copper foil (product name “CF-T9DA-SV-18”, surface asperity Sa=0.22 μm, manufactured by Fukuda Metal Foil & Powder Co., Ltd.). Drying is performed at 150° C. for one hour, and the layer A composed of aromatic polyester amide A1 and epoxy resin (a crosslinked substance of an epoxy compound) is formed on the electrolytic copper foil. A thickness of the layer A is 3 μm. Each of the solutions for forming the layer B shown in Table 1 was applied onto the layer A. Drying is performed at 50° C. for three hours, and the layer B composed of aromatic polyester amide A1 is formed on the layer A. A thickness of the layer B is 30 μm. With this, the resin layer consisting of the layer A and the layer B is formed on the copper layer.

The precursor in which the resin layer was formed on the copper layer was subjected to an annealing treatment at 300° C. for 3 hours in a nitrogen atmosphere, thereby obtaining a laminate in which the film was formed on the copper layer.

In Examples 1 and 2, and Comparative Example 1, the layer B in the film had a phase-separated structure having at least two phases, and the phase consisting of the aromatic polyester amide A1 was referred to as the first phase, and the phase consisting of PTFE or polyethylene was referred to as the second phase.

Using the laminate, a glass transition temperature (Tg1) of the first phase in the film was measured. In addition, regarding the second phase in the film, the inflection point of the storage elastic modulus, the melting point, the ratio P, the dielectric loss tangent, and the storage elastic modulus at 25° C. were measured. The ratio P means a ratio of the storage elastic modulus at a temperature higher than Tg1 by 25° C. to the storage elastic modulus at a temperature lower than Tg1 by 25° C. Regarding the film, the dielectric loss tangent, the degree of crystallinity, the glass transition temperature, and the linear thermal expansion coefficient (CTE) were measured.

In addition, using the laminate, the curling was evaluated. The measurement method and the evaluation method are as follows.

The melting point and the dielectric loss tangent of the second phase were measured by cutting out the second phase from the film.

### <Glass Transition Temperature>

The glass transition temperature was measured using a differential scanning calorimetry (DSC) device (product name “DSC-60A Plus”, manufactured by Shimadzu Corporation).

### <Storage Elastic Modulus>

The laminate was embedded in a UV resin and cut with a microtome to prepare a sample for cross section evaluation. A cross section exposed by the cutting is observed in a VE-AFM mode using a scanning probe microscope (product name “SPA400”, SII NanoTechnology Inc.), and the storage elastic modulus is measured.

### <Inflection Point of Storage Elastic Modulus>

The temperature was scanned from the low temperature side to the high temperature side to measure the storage elastic modulus, and the inflection point was calculated from the curve obtained by plotting the temperature on the lateral axis and the storage elastic modulus on the vertical axis.

### <Melting Point>

The laminate was embedded in a UV resin and cut with a microtome to prepare a sample for cross section evaluation. The melting point was measured using a differential scanning calorimetry device (product name “DSC-60A Plus”, manufactured by Shimadzu Corporation).

### <Dielectric Loss Tangent>

The dielectric loss tangent was measured by a resonance perturbation method at a frequency of 10 GHz. A 10 GHz cavity resonator (CP531 of Kanto Electronics Application & Development Inc.) is connected to a network analyzer (“E8363B” manufactured by Agilent Technology), and a measurement sample (width: 2.0 mm×length: 80 mm) is inserted into the cavity resonator, and the dielectric loss tangent of the measurement sample was measured based on a change in resonance frequency for 96 hours before and after the insertion in an environment of a temperature of 25° C. and a humidity of 60% RH.

### <Degree of Crystallinity>

X-ray diffraction (XRD) measurement was performed on the film, and a ratio of a peak area of a crystal component to a total peak area of the obtained profile was defined as a degree of crystallinity. The XRD measurement was performed at 25° C.

### <Linear Thermal Expansion Coefficient (CTE)>

A tensile load of 1 g was applied to both ends of a film having a width of 5 mm and a length of 20 mm, and a linear expansion coefficient was calculated from the inclination of TMA curve between 30° C. and 150° C. using a thermomechanical analyzer (TMA) in a case where the temperature was raised from 25° C. to 200° C. at a rate of 5° C./min, lowered to 30° C. at a rate of 20° C./min, and raised again at a rate of 5° C./min. In a case where the film was a laminate with a copper foil, the copper foil was etched with iron chloride, and the measurement was performed using a film taken out.

### <Curling>

The laminate cut into a square of 10 cm was placed on a platform, and a rod-shaped weight was placed on a diagonal line of the surface on which the film was formed. In this state, the shape of the film was observed from a direction parallel to the main surface of the film. In a case where the film had an arc shape, a peel height of the film was measured. The peel height is a height from a platform of a vertex on a side on which the weight of the film is not placed. The evaluation standards are as follows.
A: The film had an arc shape, and the peel height was 24 mm or less.
B: The film had an arc shape, and the peel height was more than 24 mm.
C: The film had an annular shape.

TABLE 1

| | | | | Second phase | | | | | | | | | | | |
|---|---|---|---|---|---|---|---|---|---|---|---|---|---|---|---|
| | First phase | | | | | Inflec- | | | | Elastic | Film | | | | |
| | | Content | | | Content | tion | Melting | | Dielec- | modulus | Dielec- | Degree of | | CTE | |
| | | [% by | Tg1 | | [% by | point | point | Ratio | tric loss | at 25° C. | tric loss | crystal- | Tg | [ppm/ | |
| | Type | mass] | [° C.] | Type | mass] | [° C.] | [° C.] | P | tangent | [GPa] | tangent | linity | [° C.] | ° C.] | Curling |
| Example 1 | A1 | 50 | 160 | C1 | 50 | 310 | 310 | 0.8 | 0.0002 | 1.4 | 0.0020 | 43 | 160 | 41 | A |
| Example 2 | A1 | 25 | 160 | C1 | 75 | 310 | 310 | 0.8 | 0.0002 | 0.7 | 0.0020 | 43 | 160 | 43 | A |
| Comparative | A1 | 25 | 160 | C2 | 75 | 110 | 110 | 0.06 | 0.0005 | 0.3 | 0.0024 | 56 | 160 | 28 | B |
| Example 1 | | | | | | | | | | | | | | | |

As shown in Table 1, in Examples 1 and 2, the phase-separated structure including at least two phases is provided, and in a case where the glass transition temperature of the first phase which is one of the at least two phases is denoted by Tg1, the second phase does not have an inflection point of a storage elastic modulus in a temperature range of 25° C. or higher and Tg1 or lower. In Examples 1 and 2, the phase-separated structure including at least two phases is provided, and in a case where the glass transition temperature of the first phase which is one of the at least two phases is denoted by Tg1, a melting point of the second phase is higher than Tg1. In Examples 1 and 2, the phase-separated structure including at least two phases is provided, and in a case where the glass transition temperature of the first phase which is one of the at least two phases is denoted by Tg1, a storage elastic modulus at a temperature higher than Tg1 of the second phase by 25° C. is 0.5 times or more a storage elastic modulus at a temperature lower than Tg1 by 25° C. Therefore, it was found that curling was suppressed in Examples 1 and 2.

On the other hand, in Comparative Example 1, the second phase has an inflection point of the storage elastic modulus in a temperature range of 25° C. or higher and Tg1 or lower. The melting point of the second phase is lower than Tg1. A storage elastic modulus at a temperature higher than Tg1 of the second phase by 25° C. is less than 0.5 times a storage elastic modulus at a temperature lower than Tg1 by 25° C. Therefore, in Comparative Example 1, curling was confirmed.

The disclosure of Japanese Patent Application No. 2022-075201 filed on Apr. 28, 2022 is incorporated in the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A film comprising:
a phase-separated structure having at least two phases,
wherein in a case where a glass transition temperature of a first phase, which is one of the at least two phases, is denoted by Tg1, a second phase which is one of the at least two phases and is different from the first phase does not have an inflection point of a storage elastic modulus in a temperature range of 25° C. or higher and the Tg1 or lower.

2. A film comprising:
a phase-separated structure having at least two phases,
wherein in a case where a glass transition temperature of a first phase, which is one of the at least two phases, is denoted by Tg1, a melting point of a second phase which is one of the at least two phases and is different from the first phase is higher than the Tg1.

3. A film comprising:
a phase-separated structure having at least two phases,
wherein in a case where a glass transition temperature of a first phase, which is one of the at least two phases, is denoted by Tg1, a storage elastic modulus of a second phase which is one of the at least two phases and is different from the first phase at a temperature higher than the Tg1 by 25° C. is 0.5 times or more a storage elastic modulus of the second phase at a temperature lower than the Tg1 by 25° C.

4. The film according to claim 1,
wherein the second phase has a storage elastic modulus at 25° C. of 10 GPa or less.

5. The film according to claim 1,
wherein a dielectric loss tangent is 0.010 or less.

6. The film according to claim 1,
wherein a degree of crystallinity is 60% or less.

7. The film according to claim 1,
wherein a glass transition temperature is 100° C. to 200° C.

8. The film according to claim 1,
wherein a melting point of the second phase is 500° C. or lower.

9. The film according to claim 1,
wherein a dielectric loss tangent of the second phase is 0.002 or less.

10. The film according to claim 1,
wherein a dielectric loss tangent of the second phase is lower than a dielectric loss tangent of the film.

11. The film according to claim 1,
wherein the second phase contains particles.

12. The film according to claim 1,
wherein a content of the second phase is 45% by mass or more with respect to a total mass of the film.

13. The film according to claim 1,
wherein the first phase contains a liquid crystal polymer.

14. The film according to claim 1,
wherein the first phase contains aromatic polyester amide.

15. The film according to claim 14,
wherein the aromatic polyester amide includes a constitutional unit represented by Formula 1, a constitutional unit represented by Formula 2, and a constitutional unit represented by Formula 3,
with respect to a total content of the constitutional unit represented by Formula 1, the constitutional unit represented by Formula 2, and the constitutional unit represented by Formula 3, and
a content of the constitutional unit represented by Formula 1 is 30 mol % to 80 mol %,
a content of the constitutional unit represented by Formula 2 is 10 mol % to 35 mol %, and
a content of the constitutional unit represented by Formula 3 is 10 mol % to 35 mol %,
—O—Ar¹—CO— Formula 1
—CO—Ar²—CO— Formula 2
—NH—Ar³—O— Formula 3
in Formula 1 to Formula 3, Ar¹, Ar², and Ar³ each independently represent a phenylene group, a naphthylene group, or a biphenylylene group.

16. A laminate comprising:
the film according to claim 1; and
a metal layer disposed on at least one surface of the film.

17. The laminate according to claim 16,
wherein a surface asperity of the metal layer on a side in contact with the film is 0.5 μm or less.
